(19) United States
(12) Patent Application Publication
(10) Pub. No.: US 2010/0224664 A1
(43) Pub. Date: Sep. 9, 2010

(54) COMPRESSOR

(76) Inventors: Takayuki Hishinuma, Gunma (JP); Yuuko Matsubara, Gunma (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(21) Appl. No.: 12/679,283

(22) PCT Filed: Aug. 22, 2008
(86) PCT No.: PCT/JP2008/065010

§ 371 Date: Mar. 19, 2010

(30) Foreign Application Priority Data
Sep. 19, 2007 (JP) 2007-242446

(51) Int. Cl. B60R 11/00

(52) U.S. Cl. 224/555

(57) ABSTRACT

A compressor mounted on a vehicle-side mounting section by using through bolts. The area of a first mounting surface of the compressor at which the compressor is mounted on the vehicle-side mounting section is set greater than the area of a second mounting surface where a seat surface for a head of each through bolt is formed. Because both the mounting surfaces have different areas, vibration is suppressed when the compressor is mounted in place. Thus, the simple improvement can effectively reduce vibration when the compressor is mounted on the vehicle-side mounting section using through bolts.

### TECHNICAL FIELD OF THE INVENTION

The present invention relates to a structure of a mounting section of a compressor body mounted on a vehicle, relating specifically to a compressor structure which can suppress vibration and noise accompanied by the vibration when the compressor is mounted.

### BACKGROUND ART OF THE INVENTION

When a compressor mounted on a vehicle is mainly incorporated in an air conditioning system for vehicles, the compressor is often mounted on a vehicle-side mounting section by using through bolts. In addition, the compressor, though sometimes being mounted directly on a vehicle body, is often mounted on a bracket as a vehicle-side mounting section, and the bracket is often mounted on a vehicle body or an engine mounted in the vehicle.

For example as shown in FIG. 4, compressor 101 is mounted through bracket 103 on engine 102 which is mounted on a vehicle by using through bolt 104. In compressor 101 having such an mounting structure, substantively isometric have been the area of mounting surface 105 for mounting on a vehicle-side mounting section shown as bracket 103 and the area of mounting surface 107 which forms the seat surface of head section 106 of through bolt 104 on the opposite side.

Besides, though a structure where a fin is provided at a boss section for mounting a compressor in order to develop the heat radiation performance of the compressor is known as a prior art shown in Patent document 1, there has not been any approach which devises the boss section for mounting in order to suppress vibration like the present invention.

Patent document 1: JP-9-112419-A

### DISCLOSURE OF THE INVENTION

### Problems to be Solved by the Invention

Therefore an object of the present invention is to provide a structure of a compressor in which the vibration in a mounting state can be efficiently suppressed by simple improvement in a case where the compressor is mounted on a vehicle-side mounting section by using through bolts as described above.

### Means for Solving the Problems

To achieve the above-described object, a compressor according to the present invention is a compressor mounted on a vehicle-side mounting section by using through bolts, characterized in that an area of a first mounting surface of the compressor at which the compressor is mounted on the vehicle-side mounting section is set greater than an area of a second mounting surface where a seat surface for a head of each through bolt is formed, and a vibration in mounted state is suppressed by providing different sizes in area to both mounting surfaces.

As shown in the after-mentioned analysis result, vibration reduction effect can be obtained by providing different area sizes to both mounting surfaces much more efficiently than by changing a shape of the other part. Therefore by simple improvements of the shape and structure in this part, vibration of the compressor in the mounting state can be suppressed effectively. Further, because the different area sizes are provided only to both mounting surfaces, no substantial change is required in the external shape of the compressor, so that a desirable vibration reduction can be achieved as keeping the lightweight property.

As to the magnitude relation between the area sizes of the above-described mounting surfaces, for example, the area of the first mounting surface is preferably not less than 1.11 times of the area of the second mounting surface. This relation corresponds to the case where the outer radius of the boss section of the second mounting surface is set to 9.5 mm when the outer radius of the boss section forming the first mounting section is 9 mm, in the after-mentioned analysis result.

Further, in order to provide different area sizes to both mounting surfaces, for example, a structure where a diameter of a boss section of the compressor into which each through bolt is inserted is gradually increased from the second mounting surface side toward the first mounting surface side can be employed. This can make it possible to give a desirable area size relation without sudden shape change, so that vibration can be suppressed as providing a desirable strength performance that can prevent a stress concentration. Such a plurality of boss sections can be provided, and the same structure may be employed for each boss section.

Furthermore, a compressor structure mounting to the vehicle-side mounting section can be substantively optional form. For example, the vehicle-side mounting section may be a bracket which is attached to either a vehicle body or an engine mounted in a vehicle.

### EFFECT ACCORDING TO THE INVENTION

Thus, the compressor according to the present invention can suppress vibration efficiently in a mounting state by simple improvement where the different area size relation is provided between the first mounting surface and the second mounting surface, in a structure mounting on the vehicle-side mounting section by using through bolts. Further, because no substantial change is required in the external shape of the compressor, a desirable vibration reduction can be achieved as keeping the lightweight property in a whole compressor.

### BRIEF EXPLANATION OF THE DRAWINGS

FIG. 1 is a schematic framework showing an example of a compressor in a mounting state according to an embodiment of the present invention.

FIG. 2 includes perspective views (a), (c) and a plan view (b) which show a measuring point where the vibration level of the compressor in a mounting state shown in FIG. 1 is measured.

FIG. 3 is a characteristic diagram for the sensitivity in the compressor in FIG. 1 for analyzing the degree of the influence caused by the size change of each section shown in FIG. 2.

FIG. 4 is a schematic framework showing an example of a conventional structure for mounting a compressor.

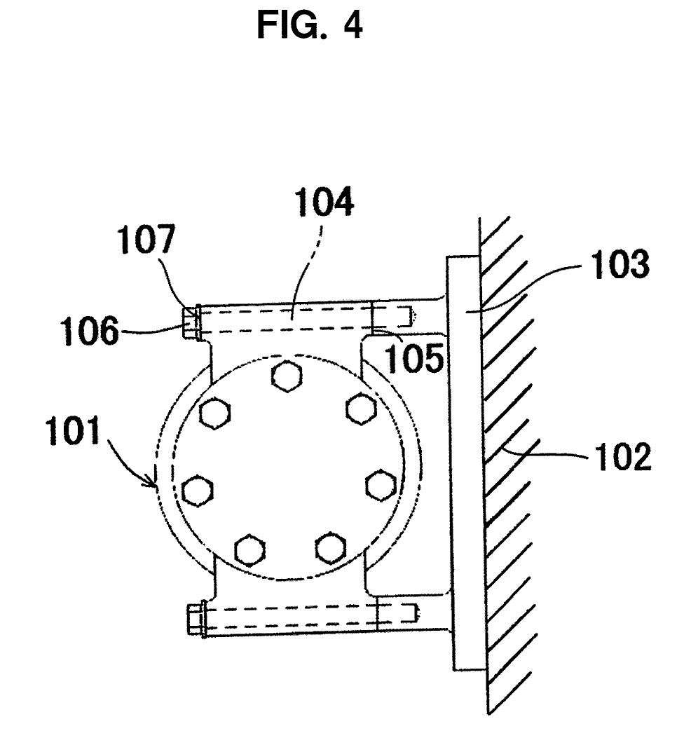

### EXPLANATION OF SYMBOLS

1: compressor
2: vehicle-side mounting section
3: through bolt
4: first mounting surface
5: head section of through bolt
6: second mounting surface
7: boss section
10: bracket

### THE BEST MODE FOR CARRYING OUT THE INVENTION

Hereinafter, desirable embodiments of the present invention will be explained as referring to figures, and an advantage of the present invention will be explained as referring to results of the quality engineering experiment using computer analysis.

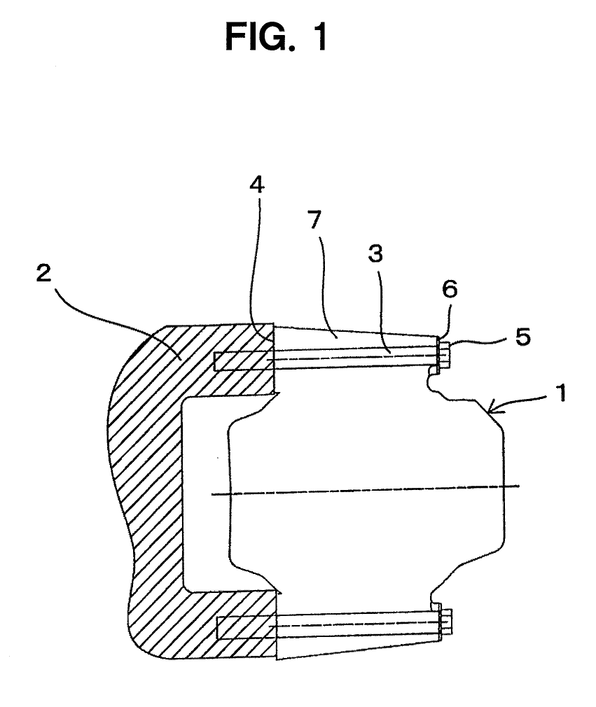

FIG. 1 shows a schematic framework showing a compressor in a mounting state according to an embodiment of the present invention. In FIG. 1, compressor 1 is mounted on vehicle-side mounting section 2 by using through bolt 3. In compressor 1, the area of first mounting surface 4 to be mounted on vehicle-side mounting section 2 of compressor 1 is set greater than the area of second mounting surface 6 which forms seat surface on the side of head section 5 of through bolt 3. Both mounting surfaces 4, 6 are prepared as can suppress vibration of compressor 1 in a mounting state by providing different areas thereto. In this embodiment, through bolt 3 is inserted in a bolt hole formed in boss section 7 of compressor 1, and the diameter of boss section 7 is gradually increased from second mounting surface 6 side toward first mounting surface 4 side in a tapered shape.

Thus, first mounting surface 4 and second mounting surface 6 are provided with different area sizes to each other, so that vibration of compressor 1 in the mounting state can be suppressed. The following analysis is performed in order to confirm that the effect of the vibration reduction is far greater than a case where the shape of the other part is changed.

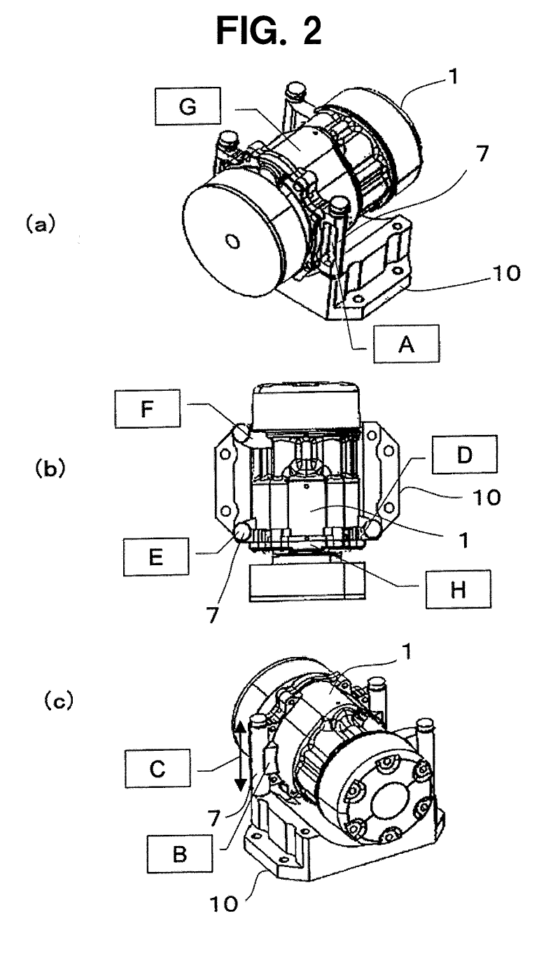

As shown in FIG. 2(a), (b), (c), the influence to vibration of compressor 1, in which each part size has been changed as shown in Table 1 so as to include the composition of the present invention, is subjected to a computer analysis as utilizing the finite element method. In other words, a case where the size of each part (A-H) shown in FIG. 2 has been changed is subjected to a computer analysis as a model, so as to determine the effect extent of how much the size change influences the vibration. Besides, symbol 10 in FIG. 2 shows a bracket as a vehicle-side mounting section in the present invention, and bracket 10 can be mounted on a vehicle body or on an engine mounted on a vehicle.

Object places to be measured and analyzed are the following symbols as shown in FIG. 2 and Table 1.

A: Existence or nonexistence of the recess on the root side of the boss section to insert the through bolt, which is expressed as “Boss recess” for the change factor in Table 1.

B: The angle of the rib provided integrally on the root side of the boss section, relative to the perpendicular from the compressor body housing surface, which is expressed as “Boss rib” for the change factor in Table 1.

C: The length of the boss section, which is expressed as “Boss length” for the change factor in Table 1.

D: The thickness of the part on the root side of the boss section, which is expressed as “Boss root thickness” for the change factor in Table 1.

E: The outer radius on the first mounting surface of the boss section, which is expressed as “Boss outer radius on 1st mounting surface side” for the change factor in Table 1, while the outer radius on the second mounting surface of the boss section is set to 9 mm in each condition.

F: The thickness of the part on the root side of the boss section on the cylinder head side, which is expressed as “Boss root thickness on cylinder head side” for the change factor in Table 1.

G: The thickness of the wall forming the crank chamber, which is expressed as “Crank chamber wall thickness” for the change factor in Table 1.

H: The thickness of the front housing, which is expressed as “Front housing thickness” for the change factor in Table 1.

Concrete numeric value for the size change in each place is shown in Table 1.

TABLE 1
Quality engineering experiment using L18
orthogonal array Factors and levels

| Measure | | Levels | | | |
|---|---|---|---|---|---|
| place | Change factor | 1 | 2 | 3 | Unit |
| A | Boss recess | Exist | Not | | |
| | | | Exist | | |
| B | Boss rib | 0 | 15 | 30 | ° |
| C | Boss length | 60 | 70 | 80 | mm |
| D | Boss root thickness | 11 | 13 | 15 | mm |
| E | Boss outer radiuson 1st | 8.5 | 9 | 9.5 | mm |
| | mounting surface side | | | | |
| F | Boss root thickness on cylinder | 13 | 15 | 17 | mm |
| | head side | | | | |
| G | Crank chamber wall thickness | 3.5 | 4 | 4.5 | mm |
| H | Fronthousing thickness | 3 | 3.5 | 4 | mm |

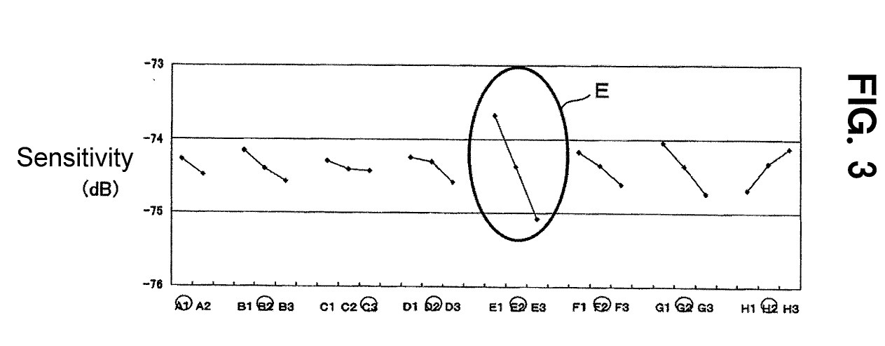

FEM (Finite Element Method) frequency response analysis was performed by using the test model shown in FIG. 2. The frequency response analysis is an analysis to calculate a stationary response (harmonic response) in a linear structure system for the load (harmonic load) which changes in a sine wave pattern, and is an analysis which can also discuss dynamic characteristics differently from a static analysis. The harmonic load in the compressor axial direction is set as a input load as a vibrational load within a range of 0-2000 Hz frequency. The effect extent to the vibration level caused by the size change when each size is changed as shown in Table 1 was analyzed as an extent of the sensitivity (effect extent) [dB]. The result is shown in FIG. 3.

FIG. 3 shows sensitivity in a condition of each size shown in Table 1. For example, E2 implies a case where the outer radius of the first mounting surface of the boss section is set to 9 mm when the outer radius of the second mounting surface of the boss section is 9 mm, namely a conventional case where the first and second mounting surfaces have the same area size. Besides, E3 implies a case where the outer radius of the first mounting surface of the boss section is set to 9.5 mm when the outer radius of the second mounting surface of the boss section is 9 mm, namely a case in the present invention where the area of the first mounting surface is set greater than the area of the second mounting surface.

As shown in FIG. 3, it is understood that change factor E has much greater effect extent than the other change factors, concerning the vibration of the compressor. Further, when the minus db in FIG. 3 gets greater in the minus direction, vibration level of the compressor can be more reduced, and therefore, it is understood that the vibration level of the compressor can be greatly suppressed efficiently by making the first mounting surface area size greater than the second mounting surface area size. In the example shown in FIG. 3 and Table 1, under the assumption that the outer radius of the second mounting surface of the boss section is set to 9 mm as change factor E, the vibration level of the compressor can be greatly suppressed by changing the first mounting surface of the boss section to 9.5 mm from 9 mm in a conventional case. Because the area size ratio is proportionate to the square of the radius ratio, the vibration level of the compressor is greatly suppressed efficiently by setting the area of the first mounting surface to not less than 1.11 times than the area of the second mounting surface.

Such an effect of the vibration reduction can be obtained regardless of the type of the compressor basically. In addition, it is understood that the vibration reduction effect is provided more surely by applying a similar form for a plurality of boss sections.

### INDUSTRIAL APPLICATIONS OF THE INVENTION

The structure of a compressor according to the present invention is applicable to every compressor in which the vibration thereof in the mounted state is required to be reduced.

1. A compressor mounted on a vehicle-side mounting section by using through bolts, characterized in that an area of a first mounting surface of said compressor at which said compressor is mounted on said vehicle-side mounting section is set greater than an area of a second mounting surface where a seat surface for a head of each through bolt is formed, and a vibration in mounted state is suppressed by providing different areas to both said mounting surfaces.

2. The compressor according to claim 1, wherein said area of said first mounting surface is not less than 1.11 times of said area of said second mounting surface.

3. The compressor according to claim 1, wherein a diameter of a boss section of said compressor into which each through bolt is inserted is gradually increased from said second mounting surface side toward said first mounting surface side.

4. The compressor according to claim 3, wherein a plurality of boss sections are provided.

5. The compressor according to claim 1, wherein said vehicle-side mounting section is a bracket which is attached to either a vehicle body or an engine mounted in a vehicle.
